(19) United States
(12) Patent Application Publication
(10) Pub. No.: US 2010/0177456 A1
(43) Pub. Date: Jul. 15, 2010

(54) METALLIZED FILM FOR CAPACITOR AND CAPACITOR USING THE SAME

(76) Inventors: Ryo Miyamoto, Shiga (JP); Kusato Hirota, Shiga (JP)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 12/160,630

(22) PCT Filed: Dec. 20, 2006
(86) PCT No.: PCT/JP2006/325332

§ 371 Date: Sep. 5, 2008

(30) Foreign Application Priority Data
Jan. 13, 2006 (JP) 2006-005672
Jul. 14, 2006 (JP) 2006-193735

(51) Int. Cl. H01G 4/018; B32B 15/08; B32B 5/00

(52) U.S. Cl. 361/273; 428/447; 428/336

(57) ABSTRACT

A metalized film for a capacitor, wherein a coating layer including a silicone composition as a constituent and a metallic layer are laminated on at least one surface of a polymer film in the order from the polymer film side.

### RELATED APPLICATIONS

This is a §371 of International Application No. PCT/JP2006/325332, with an international filing date of Dec. 20, 2006 (WO 2007/080757 A1, published Jul. 19, 2007), which is based on Japanese Patent Application Nos. 2006-005672, filed Jan. 13, 2006, and 2006-193735, filed Jul. 14, 2006.

### TECHNICAL FIELD

This disclosure relates to a metallized film for a capacitor having an excellent insulation property (hereinafter, sometimes referred to as “voltage resistance”) and a capacitor using the same.

### BACKGROUND

Conventionally, the manufacture of a capacitor having a self-healing property due to the use of a metallized film, which is a polymer film provided with a metallic layer, is widely known. For example, there is a known technology for obtaining a capacitor by alternately winding a polyester film and a metallic foil or vapor depositing metal on a film to form a metallic layer, and winding or laminating the resulting layer (Japanese Patent Application Laid-Open Nos. 63-182351 and 63-194318).

Further, it has been proposed that a capacitor using a polyphenylene sulfide film as a dielectric material of the capacitor and having excellent heat resistance, frequency characteristic and temperature characteristic is provided (Japanese Patent Application Laid Open No. 57-187327). It has been proposed that a capacitor using a polyethylene naphthalate film as a dielectric material of the capacitor and having excellent heat resistance, frequency characteristic and temperature characteristic is provided (Japanese Patent Application Laid-Open No. 63-140512). However, these capacitors are often shorted out before the self healing is achieved when low-voltage breakdown is generated and, consequently, the voltage resistance is reduced. Therefore, the application of the capacitors in the high-voltage field is restricted.

To solve such a problem, it has been proposed that a laminated polyphenylene sulfide film in which a polyester resin and a polyolefin resin are laminated on at least one surface of a polyphenylene sulfide film is used as a capacitor (Japanese Patent Application Laid-Open No. 2000-218740 and Japanese Patent No. 3080268). However, since the film obtained by laminating these resins has a thick laminated thickness and the laminated polymer is thermally unstable, the melting point of the film is lower than that of the polyphenylene sulfide film and the excellent heat resistance of the polyphenylene sulfide is undermined. Therefore, there is a problem of the reduction in a processing performance of the capacitor.

Therefore, it could be helpful to provide a metallized film for a capacitor having excellent voltage resistance and further desirably heat resistance, as well as a capacitor using the same.

### SUMMARY

We provide metallized films for capacitors characterized in that a coating layer including a silicone composition as a constituent and a metallic layer are laminated on at least one surface of a polymer film in this order from the polymer film side.

The metallized film for a capacitor excellent in its self-healing property can be obtained as described below. Further, according to a preferred aspect, a metallized film for a capacitor capable of maintaining the excellent heat resistance and excellent in a self-healing property, while using a polyphenylene sulfide film or polyethylene naphthalate excellent in heat resistance as a dielectric material of the capacitor, can be obtained.

### DETAILED DESCRIPTION

We examined metallized films for capacitors having a very high self-healing property, and have found out that a coating layer including a silicone composition which is thermally stable as a constituent may be laminated on at least one surface of a polymer film, and a metallic layer is further laminated on the coating layer.

The metallized film for a capacitor is characterized in that the coating layer including the silicone composition as a constituent is provided on at least one surface of the polymer film between the polymer film and the metallic layer.

The silicone composition denotes a resin composition including silicone in an amount of 70% by weight or more, or preferably 85% by weight or more, and the silicone composition may include an organic or inorganic additive, inactive particles or the like in an amount of less than 30% by weight, or preferably less than 15% by weight.

The silicone is a compound in which silicon or silicon and oxygen atoms are included as a skeleton, and an organic group or the like is directly bonded to the silicon atom, and is not particularly limited. Examples of the silicone include silicone oil, silane, silicone rubber, silicone resins, and the like. Among them, a silicone resin having a relatively low molecular weight, for example, a molecular weight of 100 to 5,000, in which a molecular terminal, called a silicone oligomer, is sealed with an alkoxysilyl group is preferably used from the viewpoint of a vapor deposition property. Further, it is preferable, from the viewpoint of productivity, that a double bond is included in side chains or a part of terminal groups of the silicone oligomer. In particular, a methacryl-modified silicone alkoxy oligomer is more preferable from the viewpoint of the hardenability of a coating film by a glow discharge process. The composition and the bonding state of any of these silicone compositions can be analyzed from a peak and an energy shift of each device obtained by the analysis of the surface of the coating layer by means of the) CPS (X-ray photoelectron spectroscopy), FT-IR (Fourier Transform Infrared Spectroscopy), FT-NMR (Fourier Transform Nuclear Magnetic Resonance), or the like.

A method of forming a coating layer including a silicone composition as a constituent on the surface of a polymer film is not particularly limited. Examples of the method include diluting a coating layer with an organic solvent and applying the layer by a slit die coater, and the solvent is evaporated so that the coating layer is attached, and a method wherein a heated silicone composition is sprayed out of a nozzle having thin slits or punctuate holes in vacuum, and the like.

In the latter method, in the case where a metallic layer is formed by using a vacuum vapor deposition device, a step of attaching the silicone composition can be provided in the vacuum vapor deposition device, and thus the silicone composition can be sprayed at the same time as the vapor deposition of metal. Therefore, since there is an advantageous in good productivity and the silicone composition can be evenly attached, the latter method is desirable.

Further, another preferable method is a method in which a silicone composition is attached onto a polymer film in a vacuum vapor deposition device, and then the surface to which the silicone composition is attached is subjected to the glow discharge process.

When the surface to which the silicone composition is attached is subjected to the glow discharge process, the silicone composition is plasma-polymerized or cross-linked, and a three-dimensional network is formed to form a firm silicone film. For this reason, it is considered that the film has a good self-healing property. In addition, it is considered that the process is a key point in which metal vapor deposition performance is good when the metal is vapor deposited.

A coating layer and a metallic layer can be provided on only one surface or both surfaces of a polymer film. In the case where a capacitor is produced such that only a metallized film for a capacitor is wound, the metallized film for a capacitor, in which the coating layer and the metallic layer are provided on only one surface of the polymer film, is used. On the other hand, in the case where a capacitor is produced such that a metallized film for a capacitor and a film not provided with a metallic layer are overlapped with each other and wound in the overlapping state, the metallized film for a capacitor, in which the coating layer and the metallic layer are provided on both surfaces of the polymer film, is used.

The thickness of one surface of the coating layer is preferably 1 nm to 500 nm, more preferably 1 nm to 100 nm in terms of heat resistance, and even more preferably 1 nm to 50 nm in terms of electrical characteristics. In the case where a coating layer is provided on only one of the surfaces of the polymer film, the term “thickness of one surface” denotes a thickness of the coating layer on one of the surfaces. In the case where coating layers are provided on both surfaces of the polymer film, the term “thickness of one surface” denotes thicknesses of each of the coating layers on both surfaces. The self-healing property may not be improved in the case where the thickness of the coating layer is less than 1 nm, while the heat-resistance and electrical characteristics of the polymer film tend to be deteriorated in the case where the thickness exceeds 500 nm.

The metallic layer denotes a layer formed from at least one type of metal selected from Al, Zn, Sn, Ni, Cr, Fe, Cu and Ti, and one type of alloy selected from alloys of these metals. Zn, Al, or the alloy thereof is preferably used in terms of electric characteristics and productivity of the capacitor. More preferably, the metallic layer includes 90% by mass or more of aluminum. Specifically, the aluminum alone or aluminum alloy including 90% by mass or more of aluminum is preferably used from the viewpoint of humidity resistance.

A resistance value of the metallic layer is preferably 0.5 to 100 Ω/square. When the resistance value is less than 0.5 Ω/square, capacitor characteristics to be desirably obtained may not be obtained, for example, the self-healing property and insulation resistance may be deteriorated. The resistance value exceeding 100 Ω/square may result in such a tendency that an equivalent resistance is directly increased and a dielectric loss tangent (tan δ) is deteriorated. The resistance value is more preferably 1 to 50 Ω/square, and even more preferably 2 to 30 Ω/square to more efficiently exert the effect. The resistance of the metallic layer can be controlled to be within the above range by the selection of the metal type and the thickness of the metallic layer.

Examples of the polymer film include: films made of polyesters such as polyethylene terephthalate and polyethylene naphthalate; polyolefin such as polypropylene; polystylene; polyphenylene sulfide; polyimide; polycarbonate; polyamide; polyvinyliden fluoride; polyparaxylene; and the like. Further, copolymers of these substances, and mixtures and laminated bodies of these substances and other organic polymers may be used. These high molecular compounds may include a publicly-known additive, for example, a lubricant or a plasticizer.

A main constituent of the polymer film is preferably a substance selected from polyester, polyolefin, and polyphenylene sulfide in view of the electric characteristics of the capacitor. To more efficiently exert the effect, a polymer having a melting temperature of 150° C. or more is preferably used, a polymer having a melting temperature of 200° C. or more is more preferably used, and a polymer having a melting temperature of 250° C. or more is even more preferably used as the main constituent. Therefore, among the mentioned polymers, polyphenylene sulfide or polyethylene naphthalate, which is the polymer having a melting temperature of 150° C. or more, is particularly preferable. The capacitor in which a polyphenylene sulfide film or polyethylene naphthalate is used as its dielectric material, is excellent in its heat resistance, frequency characteristic and temperature characteristic, however, inferior in its self-healing property. Therefore, the application of the capacitor in the high-voltage field is restricted. When the layer in which the silicone composition is used is laminated on the polyphenylene sulfide film or polyethylene naphthalate, the capacitor film excellent in its self-healing property and capable of maintaining excellent heat resistance of the polyphenylene sulfide or polyethylene naphthalate can be provided. The main constituent in this specification refers to a constituent which has an amount of 50% by mass or more relative to the entire polymer film.

A preferable aspect of a method of producing the metallized film for a capacitor will be described below, however, this disclosure is not limited thereto. A polymer film is unwound from an winding shaft in a vacuum vapor deposition device, a container provided with a nozzle having thin slits or continuous holes is provided in front of a cooling drum, and a silicone composition, which forms a coating layer, is heated therein and thereby evaporated and sprayed. When the nozzle is directed toward the polymer film, the coating layer is formed on the surface. Then, the surface to which the silicone composition is attached is subjected to the glow discharge process in a vacuum, and the polymer film is guided to the cooling drum. While the polymer film is cooled down on the cooling drum, and a vapor deposition source is heated and melted by means of an electrical induction heating, resistance heating or electronic beaming so that the metal coming therefrom is vapor deposited on the polymer film. The vapor deposited film is taken up by the winding shaft of the vapor deposition device, which is an intermediate product. The intermediate product is slit in a predetermined width so that a reel-shape film is obtained. In the glow discharge process, gas is locally introduced into an electrode periphery. Though the type of the gas is not particularly limited, examples thereof include O₂, Ar, CO, CO₂ and the like. O₂, Ar or mixed gas including at least one thereof is preferably used.

The processing current density is preferably 15 W·min/m² to efficiently exert the desired effect.

As the electrode for the glow discharge is preferably used a Cu, aluminum or stainless electrode. To control the characteristics to be within a desired range, a pulse DC power source is preferably used as the power source for the glow discharge, and the frequency is preferably set to 200 to 500 kHz. The film for the capacitor thus obtained is laminated or wound according to a known method, and the capacitor can be thereby obtained.

The method of producing the capacitor in which the metallized film for a capacitor is used will be described below.

In the case where a metallic foil is used as an internal electrode of the capacitor, the coating layer formed from the silicone composition is formed on the polymer film as described above. The polymer film provided with the coating layer thereon and the metallic foil are alternately overlapped and taken up with each other, for example, in such a manner that a foil sticks out or in such a manner that a tab is inserted during the winding process, so that the metallized film for a capacitor is formed, and the overlapping result is wound in such a manner that the electrode can be drawn outward, so that a capacitor device or a capacitor mother device is obtained.

In the case where a metallic thin film is used as the internal electrode of the capacitor, the coating layer formed from the silicone composition is formed on the polymer film as described above. Then, the metallic thin film, which forms the metallic layer, is laminated on the coating layer so that the metallized film for a capacitor is formed. A method of the metallization is preferably a method wherein vapor deposition is adopted. The metal to be vapor deposited is preferably metal including aluminum or zinc as its main constituent. In the case of the metallization, it is preferable to provide a non-metallized part (so-called margin) by means of a tape mask, oil margin, laser beam or the like to prevent the opposing electrodes from short-circuiting relative to each other. The film may be slit into thin tapes so that the non-metallized part is located on one end.

A typically adopted method of obtaining the capacitor of winding type, the metallized film for a capacitor is slit into the thin tapes so that the non-metallized part is located on one end, and the two films are overlapped with each other so that each device is separately wound. As an alternative method, a composite film obtained such that a film in which both surfaces are metallized is provided with a second dielectric material by means of the coating method may be wound.

In the case of the capacitor of a laminated type, the mother device wound around a drum having a large diameter or a flat plate is subjected to a heat treatment, fastened with a ring or the like, or subjected to a pressure in a thickness direction of the film, for example, pressed by flat plates in parallel with each other. After that, a step of mounting an external electrode is implemented (by metal frame spraying, conductive resin or the like), and a step of impregnating resins or oil, a step of mounting a lead wire, and a step of finishing an exterior part are implemented if necessary. Then, the capacitor can be finally obtained.

### EXAMPLES

Below are defined characteristics and numeral values of sample films obtained in the respective examples and comparative examples, and measuring and evaluation methods thereof.

### (Evaluation Method of Characteristic)

1) Thickness of Coating Layer (Layer Formed from Silicone Composition)

The sectional surface of the sample film was photographed by a transparent electronic microscope, and the thickness thereof was calculated based on an average value of values obtained at three sectional sections and a measurement magnification.

### 2) Resistance Value of Metallic Layer

The resistance of the metallic layer between electrodes of 100 mm was measured by the four electrode method, and the measured value was divided by a measured width and an inter-electrode distance, so that the resistance value of the metallic layer by the width of 10 mm and the inter-electrode distance of 10 mm was obtained, and a unit used for the resistance value is Ω/square.

### 3) Composition of Metallic Film

9 cm² of the sample film was dissolved in aqua fortis, and then a 20 ml solution was obtained. The compositions of the respective metals in the obtained solution were quantified by means of the ICP emission spectral analysis. SPS1200VR manufactured by Seiko Instruments Inc., was used as an ICP emission spectral analyzing device.

### 4) Total Thickness of Metallized Film

According to the JIS C 2151, the thickness of ten films overlapped with one another was measured by an electronic micrometer, and an average value of value obtained at five points was divided by the number of the films (10) and used as the film thickness.

### 5) Self-Healing Property

The sample film was set on a flat-plate electrode having an area of 2,500 cm² with its metal-deposited surface facing upward so that a flat-plate capacitor was formed. A voltage momentarily increased was applied to the capacitor, and a constant voltage was thereafter applied thereto. The experiment was continued until the dielectric breakdown, which started at sections no longer resistant to the applied voltage, was generated at 20 sections in the film. After the experiment, a clearing property index represented by the following equation was calculated. The self-healing property was determined to be good in the case where the clearing property index was 90% or more.

clearing property index(%)=[(Ti−(W+2T)]/Ti×100
measured area: 225 cm²
Ti: number of generated dielectric breakdowns
W: number of two overlapping dielectric breakdowns
T: number of at least three overlapping dielectric breakdowns.
Note: overlapping denotes that the dielectric breakdown is generated again within a radial of the number of the generated dielectric breakdowns generated earlier.

### 6) Heat Resistance of Capacitor

The capacitor device was dipped in melting solder at 255° C. for five seconds so that the rate of change of capacitance was measured. The measured value is represented by ΔC/C×100, and the heat resistance was evaluated. C denotes the capacitance before dipping, and ΔC denotes a value obtained by subtracting the capacitance before dipping from the capacitance after the dipping. The evaluation was given based on the following criteria. The capacitance of the capacitor was measured by an automatic capacitance bridge.

| | | |
|---|---|---|
| A: | ΔC/C × 100 ≧ 0 | very good heat resistance |
| B: | 0 > ΔC/C × 100 ≧ −5 | good heat resistance |
| C: | −5 > ΔC/C × 100 ≧ −10 | heat resistance in practical range |
| D: | −10 > ΔC/C × 100 | poor heat resistance |

### 7) Melting Temperature

The differential scanning calorimeter, DSC (RDC220), manufactured by Seiko Instruments Inc., was used to measure the melting temperature, and the disk station (SSC/5200) manufactured by the same company was used as a data analyzer. 5 mg of a specimen was heated to reach 340° C. from room temperature on an aluminum saucer at a temperate-increase rate of 20° C./min, continuously melted at 340° C. for five minutes, and rapidly cooled down to be solidified and retained for five minutes, and then, heated at a temperate-increase rate of 20° C./min from room temperature. A peak temperature of an endoergic peak observed in the melting process was defined as a melting temperature.

### Example 1

A coating layer formed from a silicone composition (SILICONE X-40-2655A manufactured by Shin-Etsu Chemical Co., Ltd.) was vapor deposited in a thickness of 0.5 nm on one surface of a polyphenylene sulfide film having a thickness of 6.0 μm by means of the vacuum vapor deposition. Then, a glow discharge was generated on the surface of the coating layer by means of a pulse DC power source of 250 kHz and 5 kW while a very small quantity of O₂ gas was supplied, so that the glow discharge process was performed (processing current density E=27.8 W·min/m²). After that, aluminum was vapor deposited on the coating-layer side so that the resistance value of the metallic layer was 2 Ω/square, which was taken up by a winding shaft. As a result, an aluminum-vapor deposited film (metallized film for a capacitor) was obtained. The running speed of the polymer film during the vapor deposition was 300 m/min. The amount of the silicone composition to be vapor deposited was controlled by a vapor pressure of the nozzle.

The obtained aluminum-vapor deposited film was cut into thin reels having a width of 20 mm and a margin width of 1 mm. When the thickness of the coating layer of the obtained aluminum-vapor deposited film was measured, it was 0.5 nm. When the clearing property index of the obtained aluminum-vapor deposited film was measured, it was 91%. Therefore, the self-healing property was good.

The thin reels were wound around a core having an outer diameter of 9 mm, and subjected to processes such as metallized contact and heat treatment, and an electrode terminal was soldered. As a result, dry and bare capacitor devices for evaluation were obtained. These devices were evaluated for the heat resistance according to the above-mentioned method, and as a result, the heat resistance was ΔC/C×100=0, and was very good.

### Example 2

The aluminum-vapor deposited film was obtained in a manner similar to that of Example 1, except that the thickness of the coating layer was 5 nm. The resistance value of the metallic layer of the obtained aluminum-vapor deposited film was 2 Ω/square, and the thickness of the coating layer was 5 nm. When the clearing property index of the obtained aluminum-deposited film was measured, it was 100% and the self-healing property was good. In the heat-resistance evaluation carried out in a manner similar to Example 1, the heat resistance was ΔC/C×100=0, and was very good.

### Example 3

The aluminum-vapor deposited film was obtained in a manner similar to that of Example 1, except that the thickness of the coating layer was 20 nm. The resistance value of the metallic layer of the obtained aluminum-vapor deposited film was 2 Ω/square, and the thickness of the coating layer was 20 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=0, and was very good.

### Example 4

The aluminum-vapor deposited film was obtained in a manner similar to that of Example 1, except that the thickness of the coating layer was 100 nm. The resistance value of the metallic layer of the obtained aluminum-vapor deposited film was 2 Ω/square, and the thickness of the coating layer was 100 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=0, and was very good.

### Example 5

The aluminum-vapor deposited film was obtained in a manner similar to that of Example 1, except that the thickness of the coating layer was 400 nm. The resistance value of the metallic layer of the obtained aluminum-vapor deposited film was 2 Ω/square, and the thickness of the coating layer was 400 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=0, and was very good.

### Example 6

The aluminum-vapor deposited film was obtained in a manner similar to that of Example 1, except that the thickness of the coating layer was 600 nm. The resistance value of the metallic layer of the obtained aluminum-vapor deposited film was 2 Ω/square, and the thickness of the coating layer was 600 nm. When the clearing property index of the obtained aluminum-Vapor deposited film was measured, it was 100% and the self-healing property was good. In the heat-resistance evaluation carried out in a manner similar to Example 1, the heat resistance was ΔC/C×100=−3, and was good.

### Example 7

The aluminum-vapor deposited film was obtained in a manner similar to that of Example 1, except that the thickness of the coating layer was 1,000 nm. The resistance value of the metallic layer of the obtained aluminum-vapor deposited film was 2 Ω/square, and the thickness of the coating layer was 1,000 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=−10, and was in the practical range.

### Example 8

A zinc-vapor deposited film was obtained in a manner similar to that of Example 1, except that the vapor deposited metal was zinc. The resistance value of the metallic layer of the obtained zinc-vapor deposited film was 2 Ω/square, and the thickness of the coating layer was 20 nm. When the clearing property index of the obtained zinc-vapor deposited film was measured, it was 95% and the self-healing property was good. In the heat-resistance evaluation carried out in a manner similar to Example 1, the heat resistance was ΔC/C×100=0, and was very good.

### Example 9

The aluminum-vapor deposited film was obtained in a manner similar to that of Example 1, except that the silicone composition was SILICONE X-41-1805 manufactured by Shin-Etsu Chemicals Co., Ltd. The resistance value of the metallic layer of the obtained aluminum-vapor deposited film was 2 Ω/square, and the thickness of the coating layer was 20 nm. When the clearing property index of the obtained aluminum-vapor deposited film was measured, it was 95% and the self healing property was good. In the heat-resistance evaluation carried out in a manner similar to Example 1, the heat resistance was ΔC/C×100=0, and was very good.

### Example 10

The aluminum-vapor deposited film was obtained in a manner similar to that of Example 1, except that the silicone composition was silicone oil (BY16-152 manufactured by Dow Corning Toray Co., Ltd.). The resistance value of the metallic layer of the obtained aluminum-vapor deposited film was 2 Ω/square, and the thickness of the coating layer was 20 nm. When the clearing property index of the obtained aluminum-vapor deposited film was measured, it was 97% and the self-healing property was good. In the heat-resistance evaluation carried out in a manner similar to Example 1, the heat resistance was ΔC/C×100=0, and was very good.

### Example 11

The silicone composition (SILICONE X-40-2655A manufactured by Shin-Etsu Chemicals Co., Ltd.) was vapor deposited on a polyethylene terephthalate film having a thickness of 5.4 μm by means of the vacuum vapor deposition so that the thickness of the coating layer was 20 nm. As a result, a film for a capacitor was obtained. After that, aluminum was vapor deposited on the coating-layer side of the film for a capacitor by means of the vacuum vapor deposition, so that the resistance value of the metallic layer was 2 Ω/square. When the thickness of the coating layer of the obtained aluminum-vapor deposited film was measured, the thickness was 20 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=−3, and was good.

### Example 12

The silicone composition (SILICONE X-40-2655A manufactured by Shin-Etsu Chemicals Co., Ltd.) was vapor deposited on a polypropylene film having a thickness of 4.3 μm by means of the vacuum vapor deposition so that the thickness of the coating layer was 20 nm. As a result, a film for a capacitor was obtained. After that, aluminum was vapor deposited on the coating-layer side of the film for a capacitor by means of the vacuum vapor deposition, so that the resistance value of the metallic layer was 2 Ω/square. When the thickness of the coating layer of the obtained aluminum-vapor deposited film was measured, the thickness was 20 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=−10, and within the practical range.

### Example 13

The silicone composition (SILICONE X-40-2655A manufactured by Shin-Etsu Chemicals Co., Ltd.) was vapor deposited on a polyethylene terephthalate film having a thickness of 6.0 μm so that the thickness of the coating layer was 20 nm. As a result, a film for a capacitor was obtained. After that, aluminum was vapor deposited on the coating-layer side of the film for a capacitor by means of the vacuum vapor deposition, so that the resistance value of the metallic layer was 2 Ω/square. When the thickness of the coating layer of the obtained aluminum-vapor deposited film was measured, it was 20 nm. When the clearing property index of the obtained aluminum-vapor deposited film was measured, it was 100% and the self-healing property was good. In the heat-resistance evaluation carried out in a manner similar to Example 1, the heat resistance was ΔC/C×100=0, and was very good.

### Comparative Example 1

The aluminum-vapor deposited film was obtained in a manner similar to that of Example 1, except that the step of depositing the silicone composition was not performed at all. The resistance value of the metallic layer of the obtained aluminum-vapor deposited film was 2 Ω/square. When the clearing property index of the obtained aluminum-vapor deposited film was measured, it was 75% and the self-healing property was poor. In the heat-resistance evaluation carried out in a mariner similar to Example 1, the heat resistance was ΔC/C×100=0, and was very good.

### Comparative Example 2

The aluminum-vapor deposited film was obtained in a manner similar to that of Example 11, except that the step of depositing the silicone composition was not performed at all. The resistance value of the metallic layer of the obtained aluminum-vapor deposited film was 2 Ω/square. When the clearing property index of the obtained aluminum-vapor deposited film was measured, it was 84% and was lower than the value obtained in Example 9. In the heat-resistance evaluation carried out in a manner similar to Example 1, the heat resistance was ΔC/C×100=−3, and was good.

### Comparative Example 3

The aluminum-vapor deposited film was obtained in a manner similar to that of Example 12, except that the step of depositing the silicone composition was not performed at all. The resistance value of the metallic layer of the obtained aluminum-vapor deposited film was 2 Ω/square. When the clearing property index of the obtained aluminum-vapor deposited film was measured, it was 87% and was lower than the value obtained in Example 10. In the heat-resistance evaluation carried out in a manner similar to Example 1, the heat resistance was ΔC/C×100=−10, and within the practical range.

### Comparative Example 4

The aluminum-vapor deposited film was obtained in a manner similar to that of Example 13, except that the step of depositing the silicone composition was not performed at all. The resistance value of the metallic layer of the obtained aluminum-vapor deposited film was 2 Ω/square. When the clearing property index of the obtained aluminum-vapor deposited film was measured, it was 74% and the self-healing property was poor. In the heat-resistance evaluation carried out in a manner similar to Example 1, the heat resistance was ΔC/C×100=0, and was very good.

Table 1 shows the measurement and evaluation results in examples and comparative examples.

TABLE 1

| | | Melting | Thickness of | | Resistance value | | Thickness | Clearing | Heat |
|---|---|---|---|---|---|---|---|---|---|
| | Polymer | temperature | polymer | Metallic | of metallic | Coating | of coating | property | resistance |
| | film | (° C.) | film (μm) | layer | layer (Ω/square) | layer | layer (nm) | index (%) | ΔC/C × 100 |
| Example 1 | Polyphenylene | 285 | 6 | Al | 2 | Methacryl- | 0.5 | 91 | A |
| | sulfide | | | | | modified | | | |
| | | | | | | oligomer | | | |
| Example 2 | Polyphenylene | 285 | 6 | Al | 2 | Methacryl- | 5 | 100 | A |
| | sulfide | | | | | modified | | | |
| | | | | | | oligomer | | | |
| Example 3 | Polyphenylene | 285 | 6 | Al | 2 | Methacryl- | 20 | 100 | A |
| | sulfide | | | | | modified | | | |
| | | | | | | oligomer | | | |
| Example 4 | Polyphenylene | 285 | 6 | Al | 2 | Methacryl- | 100 | 100 | A |
| | sulfide | | | | | modified | | | |
| | | | | | | oligomer | | | |
| Example 5 | Polyphenylene | 285 | 6 | Al | 2 | Methacryl- | 400 | 100 | A |
| | sulfide | | | | | modified | | | |
| | | | | | | oligomer | | | |
| Example 6 | Polyphenylene | 285 | 6 | Al | 2 | Methacryl- | 600 | 100 | B |
| | sulfide | | | | | modified | | | |
| | | | | | | oligomer | | | |
| Example 7 | Polyphenylene | 285 | 6 | Al | 2 | Methacryl- | 1000 | 100 | C |
| | sulfide | | | | | modified | | | |
| | | | | | | oligomer | | | |
| Example 8 | Polyphenylene | 285 | 6 | Zn | 2 | Methacryl- | 20 | 100 | A |
| | sulfide | | | | | modified | | | |
| | | | | | | oligomer | | | |
| Example 9 | Polyphenylene | 285 | 6 | Al | 2 | Methacryl- | 20 | 95 | A |
| | sulfide | | | | | modified | | | |
| | | | | | | oligomer | | | |
| Example 10 | Polyphenylene | 285 | 6 | Al | 2 | Methacryl- | 20 | 97 | A |
| | sulfide | | | | | modified | | | |
| | | | | | | oil | | | |
| Example 11 | Polyethylene | 265 | 5.4 | Al | 2 | Methacryl- | 20 | 100 | B |
| | terephthalate | | | | | modified | | | |
| | | | | | | oligomer | | | |
| Example 12 | Polypropylene | 165 | 4.3 | Al | 2 | Methacryl- | 20 | 100 | C |
| | | | | | | modified | | | |
| | | | | | | oligomer | | | |
| Example 13 | Polyethylene | 265 | 6 | Al | 2 | Methacryl- | 20 | 100 | A |
| | naphthalate | | | | | modified | | | |
| | | | | | | oligomer | | | |
| Comparative | Polyphenylene | 285 | 6 | Al | 2 | No coating | — | 75 | A |
| Example 1 | sulfide | | | | | layer | | | |
| Comparative | Polyethylene | 265 | 5.4 | Al | 2 | No coating | — | 84 | B |
| Example 2 | terephthalate | | | | | layer | | | |
| Comparative | Polypropylene | 165 | 4.3 | Al | 2 | No coating | — | 87 | C |
| Example 3 | | | | | | layer | | | |
| Comparative | Polyethylene | 265 | 6 | Al | 2 | No coating | — | 74 | A |
| Example 4 | naphthalate | | | | | layer | | | |

### INDUSTRIAL APPLICABILITY

A metallized film for a capacitor which is excellent in its self-healing property can be obtained without loss of an excellent heat resistance of a polyphenylene sulfide film or polyethylene naphthalate. The film is suitably used for electric devices of an automobile and a train, controlling engines and motors, an inverter smoothening capacitor, lighting and the like.

1. A metallized film for a capacitor, wherein a coating layer including a silicone composition as a constituent and a metallic layer are laminated on at least one surface of a polymer film in the order from the polymer film side.

2. The metallized film for a capacitor according to claim 1, wherein
the thickness of the coating layer is 1 nm to 500 nm.

3. The metallized film for a capacitor according to claim 1, wherein
a polymer forming the silicone composition includes an organic group having a double bond in a side chain or a part of terminal groups thereof.

4. The metallized film for a capacitor according to claim 1, wherein
the organic group is a methacrylic group.

5. The metallized film for a capacitor according to claim 1, wherein
a main constituent of the polymer film is a polymer having a melting temperature of 150° C. or more.

6. The metallized film for a capacitor according to claim 5, wherein
the polymer is polyphenylene sulfide or polyethylene naphthalate.

7. A capacitor comprising the metallized film for a capacitor according to claim 1.

8. A metallized film comprising:
a polymer film;
a coating layer comprising a silicone composition laminated to at least one surface of the polymer film; and
a metallic layer laminated onto a surface of the coating layer.

9. The metallized film according to claim 8, wherein
the thickness of the coating layer is 1 nm to 500 nm.

10. The metallized film for a capacitor according to claim 8, wherein
a polymer forming the silicone composition includes an organic group having a double bond in a side chain or a part of terminal groups thereof.

11. The metallized film for a capacitor according to claim 8, wherein
the organic group is a methacrylic group.

12. The metallized film for a capacitor according to claim 8, wherein
a main constituent of the polymer film is a polymer having a melting temperature of 150° C. or more.

13. The metallized film for a capacitor according to claim 12, wherein
the polymer is polyphenylene sulfide or polyethylene naphthalate.

14. A capacitor comprising the metallized film for a capacitor according to claim 8.
